(19) United States
(12) Patent Application Publication
(10) Pub. No.: US 2010/0038810 A1
(43) Pub. Date: Feb. 18, 2010

(54) METHOD FOR MAKING A FOAMED SOLE

(76) Inventor: Wen-Kuo Tsai, Nantou County (TW)

Correspondence Address: CHRISTIE, PARKER & HALE, LLP, PO BOX 7068, PASADENA, CA, 91109-7068, US

(21) Appl. No.: 12/427,644

(22) Filed: Apr. 21, 2009

(51) Int. Cl. B29C 43/14

(52) U.S. Cl. 264/46.4

(57) ABSTRACT

A method for making a foamed sole includes the steps of: a) preparing a mold having a lower mold part, an upper mold part, and an intermediate plate removably disposed between the lower and upper mold parts, the lower mold part having a lower mold cavity, the upper mold part having an upper mold cavity; b) molding a first molding material in one of the upper mold cavity and the lower mold cavity to form a first sole portion while the intermediate plate is placed between the upper and lower mold parts; c) removing the intermediate plate and covering the lower mold part with the upper mold part; and d) molding a second molding material in the other of the upper mold part and the lower mold part to form a second sole portion in the presence of the first sole portion.

### BACKGROUND OF THE INVENTION

1. Field of the Invention

The invention relates to a method for making a sole, more particularly to a method for making a foamed sole.

2. Description of the Related Art

A resilient sole is generally formed by molding a foaming material. Therefore, the foamed sole has uniform resilience at all parts thereof. That is, the flexibility of the sole is identical at all levels thereof, and thus the application of the sole is limited.

A conventional composite sole composed of two layers having different hardness is made by separately molding the layers and adhering the layers together using glue to form the composite sole. Although the comfort of the composite sole is improved, the respective layers of the sole are liable to separate from each other due to that fact that they are bound to each other merely using glue. Furthermore, the process for making the sole is relatively costly and complicated since an adhering step is required.

### SUMMARY OF THE INVENTION

Therefore, the object of the present invention is to provide a method for making a foamed sole, in which layers having different hardness for forming the foamed sole can be integrated with each other without using glue.

The method for making a foamed sole according to this invention includes the steps of: a) preparing a mold having a lower mold part, an upper mold part opposite to the lower mold part, and an intermediate plate removably disposed between the lower mold part and the upper mold part, the lower mold part having a top surface and a lower mold cavity recessed from the top surface, the upper mold part having a bottom surface and an upper mold cavity recessed from the bottom surface, the intermediate plate having a top surface to close the upper mold cavity of the upper mold part and a bottom surface to close the lower mold cavity of the lower mold part; b) molding a first molding material in one of the upper mold cavity and the lower mold cavity to form a first sole portion while the intermediate plate is placed between the upper and lower mold parts; c) removing the intermediate plate and covering the lower mold part with the upper mold part; and d) molding a second molding material in the other of the upper mold part and the lower mold part to form a second sole portion in the presence of the first sole portion, thereby bonding together the first and second sole portions.

### BRIEF DESCRIPTION OF THE DRAWINGS

Other features and advantages of the present invention will become apparent in the following detailed description of the preferred embodiment with reference to the accompanying drawings, of which:

FIGS. 1 to 5 are sectional views showing consecutive steps of a preferred embodiment of a method for making a foamed sole according to this invention.

### DETAILED DESCRIPTION OF THE PREFERRED EMBODIMENT

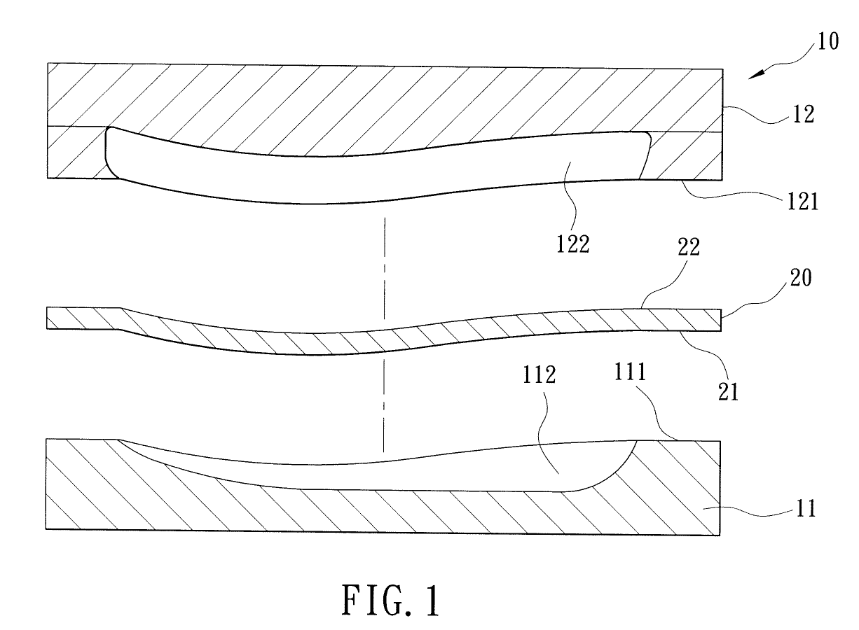

Referring to FIGS. 1 to 5, the preferred embodiment of the method for making a foamed sole of this invention includes the steps of:

A) preparing a mold 10:

Specifically referring to FIG. 1, the mold 10 has a lower mold part 11, an upper mold part 12 opposite to the lower mold part 11, and an intermediate plate 20 removably disposed between the lower mold part 11 and the upper mold part 12. The lower mold part 11 has a top surface 111 and a lower mold cavity 112 recessed from the top surface 111. The upper mold part 12 has a bottom surface 121 and an upper mold cavity 122 recessed from the bottom surface 121. The intermediate plate 20 has a top surface 22 to close the upper mold cavity 122 of the upper mold part 12 and a bottom surface 21 to close the lower mold cavity 112 of the lower mold part 11.

B) molding a first molding material:

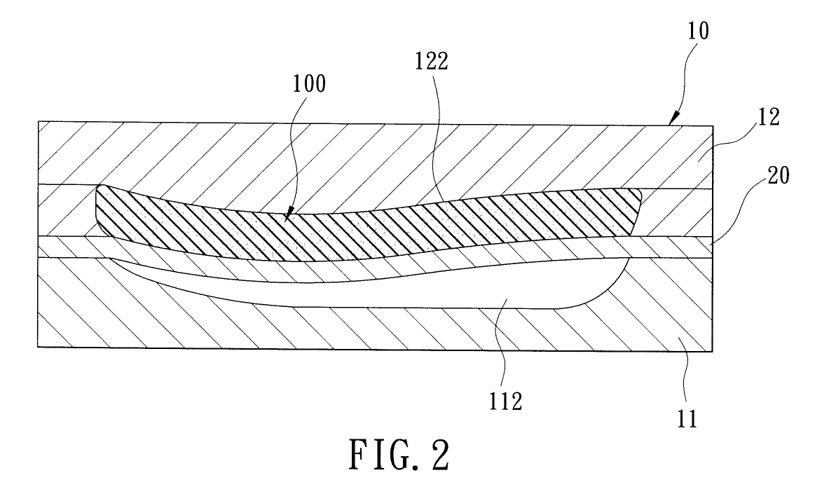

Specifically referring to FIG. 2, the first molding material, such as a polyurethane material, is filled and molded in the upper mold cavity 122 of the upper mold part 12 to form a first sole portion 100 while the intermediate plate 20 is placed between the upper and lower mold parts 12, 11. Preferably, the first sole portion 100 is formed by molding the polyurethane material at a mold cavity temperature ranging from 60 to 70° C.

C) removing the intermediate plate 20:

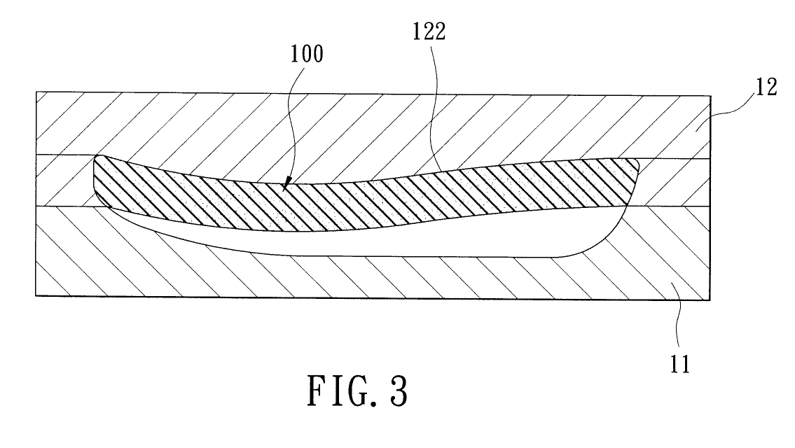

Specifically referring to FIG. 3, the intermediate plate 20 is removed, and the lower mold part 11 is covered with the upper mold part 12 so that the mold 10 is closed. The first sole portion 100 remains in the upper mold cavity 122 of the upper mold part 12 at this time.

D) molding a second molding material:

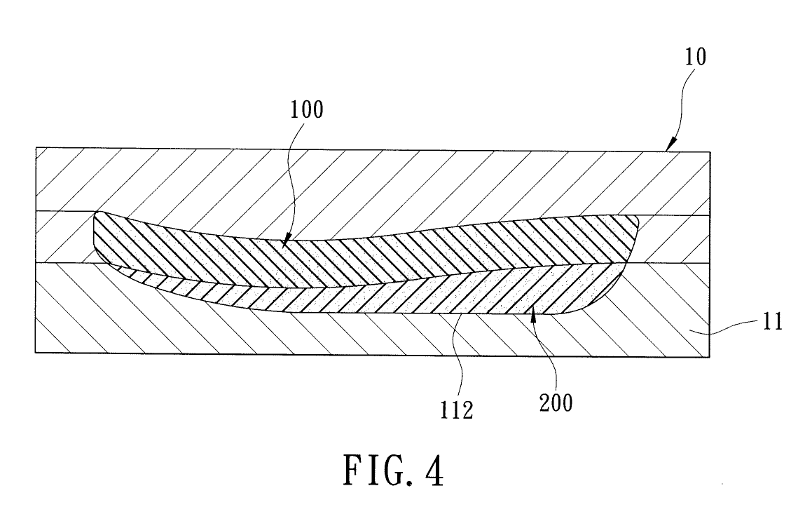

Specifically referring to FIG. 4, the second molding material, such as a polyurethane material, is filled and molded in the lower mold cavity 112 of the lower mold part 11 so as to form a second sole portion 200 in the presence of the first sole portion 100, thereby bonding together the first and second sole portions 100, 200. In the preferred embodiment, the second sole portion 200 has a hardness smaller than that of the first sole portion 100. Preferably, the second sole portion 200 is formed by molding the polyurethane material at a mold cavity temperature ranging from 60 to 70° C.

Preferably, the first sole portion 100 has a hardness ranging from 60 to 75. More preferably, the hardness of the first sole portion 100 is 70. Preferably, the second sole portion 200 has a hardness ranging from 20 to 35. More preferably, the hardness of the second sole portion 200 is 25. The hardness is measured using a hardness tester (Asker Shore C).

E) opening the mold 10:

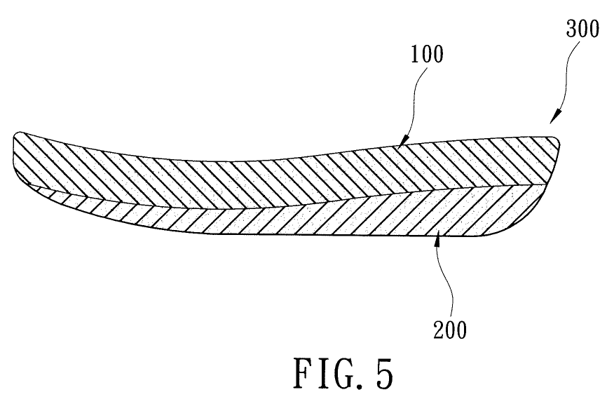

Specifically referring to FIG. 5, the mold 10 is opened so as to obtain a foamed sole 300 composed of the first and second sole portions 100, 200 bonded directly to each other.

The polyurethane materials suitable for the making the first and second sole portions 100, 200 can be a polyether type polyurethane or a polyester type polyurethane, and the former is preferable.

In view of the aforesaid, the foamed sole 300 composed of the first and second sole portions 100, 200 having different hardness and bonded directly to each other can be simply made by the method of this invention using the mold 10. Therefore, the production cost is reduced, and the industrial utility is increased.

It should be noted that, if the second sole portion 200, which has a hardness smaller than that of the first sole portion 100, is molded prior to the first sole portion 100, the bonding of the first sole portion 100 to the second sole portion 200 will be unsatisfactory due to the molding conditions, gravity, etc. of the first sole portion 100 during the molding of the first sole portion 100. Therefore, in the method for making a foamed sole of this invention, the first sole portion 100 is first molded in the upper mold cavity 122 of the upper mold part 12. In this embodiment, the intermediate plate 20 is provided to separate the upper mold cavity 122 of the upper mold part 12 from the lower mold cavity 112 of the lower mold part 11 during the molding of the first sole portion 100.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for making a foamed sole, comprising the steps of:
a) preparing a mold having a lower mold part, an upper mold part opposite to the lower mold part, and an intermediate plate removably disposed between the lower mold part and the upper mold part, the lower mold part having a top surface and a lower mold cavity recessed from the top surface, the upper mold part having a bottom surface and an upper mold cavity recessed from the bottom surface, the intermediate plate having a top surface to close the upper mold cavity of the upper mold part and a bottom surface to close the lower mold cavity of the lower mold part;
b) molding a first molding material in one of the upper mold cavity and the lower mold cavity to form a first sole portion while the intermediate plate is placed between the upper and lower mold parts;
c) removing the intermediate plate and covering the lower mold part with the upper mold part; and
d) molding a second molding material in the other of the upper mold part and the lower mold part to form a second sole portion in the presence of the first sole portion, thereby bonding together the first and second sole portions.

2. The method as claimed in claim 1, wherein the step b) is conducted by molding the first molding material in the upper mold part, the step d) is conducted by molding the second molding material in the lower mold part, and the second sole portion has a hardness smaller than that of the first sole portion.

3. The method as claimed in claim 1, wherein the steps b) and d) are respectively conducted at a mold cavity temperature ranging from 60 to 70° C.

4. The method as claimed in claim 1, wherein the first molding material and the second molding material are selected from the group consisting of a polyether type polyurethane and a polyester type polyurethane.
